(19) United States
(12) Patent Application Publication
(10) Pub. No.: US 2021/0076693 A1
(43) Pub. Date: Mar. 18, 2021

(54) TRANSPORT CONTAINER WITH GAS SELECTIVE MEMBRANE EXHAUST

(71) Applicant: AVCATECH LABORATORIES PTY LTD, Essendon Fields (AU)

(72) Inventors: Lee James JONES, Victoria (AU); Sanjay SAVUR, Victoria (AU)

(21) Appl. No.: 16/967,189

(22) PCT Filed: Feb. 5, 2019
(86) PCT No.: PCT/AU2019/050082

§ 371 Date: Aug. 4, 2020

(30) Foreign Application Priority Data
Feb. 5, 2018 (AU) 2018900348

(51) Int. Cl. A23B 7/148; A23L 3/3418

(52) U.S. Cl. CPC A23B 7/148; B65D 88/741; A23L 3/3418

(57) ABSTRACT

Described herein is a method for operating a refrigerated stripping container containing respiring produce, the method including: passing a cooled CO₂-rich air stream from an internal environment within the shipping container through a CO₂ selective membrane of a membrane system to produce a cooled CO₂-lean air stream and a CO₂-rich permeate stream; retaining or returning the cooled CO₂-lean air stream to the internal environment; and exhausting the CO₂-rich permeate stream to an external environment outside of the shipping container: drawing external air or permitting external air to pass into the shipping container through an air vent with a pre-set fixed opening of the shipping container in a volume to at least balance a volume difference between the cooled CO₂-rich air stream and the cooled CO₂-lean air stream; wherein the membrane system is operated according to a pre-set mode, and the pre-set mode is independent of a measured gas concentration or pressure of the internal environment; and the pre-set fixed opening of the vent is selected based on one or more characteristics of the respiring produce and the pre-set mode of the membrane system.

### FIELD OF THE INVENTION

The present invention relates generally to a method of, and apparatus for, controlling gas composition within a refrigerated container or other cooled enclosure, such as to extend the life of perishable goods during transport or storage within the container or enclosure, while reducing the load required for cooling of the container or enclosure.

### BACKGROUND OF THE INVENTION

In order to prolong the storage life of perishable goods (such as fruit and vegetables) stored in sealed controlled atmosphere containers during transportation or storage it is generally important to control at least some environmental conditions within the container. This is because environmental parameters, for example temperature and gas composition within the container, affect the rate of respiration and deterioration of goods after harvest.

The conventional method of extending storage life of produce has been to refrigerate the sealed container and to reduce carbon dioxide levels (as carbon dioxide is generated by respiring produce), while maintaining a controlled atmosphere within that container (e.g. maintaining oxygen and nitrogen at desired levels). However if the oxygen concentration is reduced too much or the carbon dioxide concentration rises too high, then the perishable product may be damaged, resulting in even more rapid deterioration than might occur if no treatment was applied. Consequently it is desirable to be able to adjust the composition of the atmosphere within the sealed chamber and apparatus for adjusting the atmosphere in the chamber has accordingly been developed.

Applicant's invention described in WO 2000/023350 entitled ‘Apparatus for controlled venting of a chamber’ proposed a new approach of maintaining the controlled environment within a substantially sealed chamber containing respiring produce. The method is carried out without monitoring the carbon dioxide level in the sealed chamber and involved monitoring the oxygen level in the chamber and admitting ambient air into the sealed chamber when the oxygen level is detected to have fallen below an oxygen set point. Carbon dioxide is removed from the sealed chamber at a predetermined rate by way of a selected quantity of carbon dioxide absorbing material stored within the sealed container. The predetermined rate in the process is selected before the storage/journey such that the carbon dioxide concentration within the sealed chamber will not exceed a predetermined amount.

Other known methods for controlling the atmosphere within a sealed container utilise a permeable membrane within the sealed container which membrane is selective for removing certain gases while retaining others. That is, the membrane allows some gases to pass through, whilst excluding or minimising the passage of certain other gases.

The selective membrane is installed in the sealed container as a liner layer which defines a buffer zone which can be opened to the ambient air outside the sealed container, or manipulated in other ways. Imposing a constant partial pressure difference across the membrane has the effect of selective removal of gases into the buffer zone. Such techniques advantageously avoid the need for carbon dioxide absorbing materials.

Applicant's invention described in WO 2014/066952 entitled ‘Improvements in control of gas composition within a container’ describes a method controlling the atmosphere within a substantially sealed container by removing carbon dioxide from the sealed chamber of a shipping container using a membrane system. In this publication, the Applicant proposed a method of controlling the atmosphere in which air from within the sealed chamber was passed through the membrane system to remove CO₂ whilst the air pressure inside the chamber was actively monitored. In response to a change in pressure, a controller would actuate an inlet valve on the shipping container to introduce external air into the container in an amount to result in the air within the sealed chamber having a set gas composition.

The present invention provides a new method of controlling the environment in a container or other enclosure, a new container or enclosure, and apparatus for controlling the environment in such a container or enclosure.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect of the invention, there is provided a method for operating a refrigerated shipping container or other cooled enclosure containing respiring produce, the method including:

passing a cooled CO₂-rich air stream from an internal environment within the enclosure through a CO₂ selective membrane of a membrane system to produce a cooled CO₂-lean air stream and a CO₂-rich permeate stream;

retaining or returning the cooled CO₂-lean air stream to the internal environment; and

exhausting the CO₂-rich permeate stream to an external environment outside of the enclosure;

drawing external air or permitting external air to pass into the enclosure through an air vent with a pre-set fixed opening of the enclosure in a volume to at least balance a volume difference between the cooled CO₂-rich air stream and the cooled CO₂-lean air stream;

wherein the membrane system is operated according to a pre-set mode, and the pre-set mode is independent of a measured gas concentration or pressure of the internal environment; and

the pre-set fixed opening of the vent is selected based on one or more characteristics of the respiring produce and the pre-set mode of the membrane system.

An advantage of this method is that less ambient air is introduced into the refrigerated shipping container or other cooled enclosure to maintain desired O₂ and CO₂ levels in comparison with a system that is the same, but either lacks the membrane system or has a membrane system that is not operating in accordance with the invention. Reducing the amount of ambient air into the system also reduces the amount of energy carried into the system with that ambient air, and consequently a refrigeration system of the cooled enclosure has lower load requirements. In certain embodiments, an additional benefit is that the overall energy requirement to operate the refrigerated shipping container or other cooled enclosure is reduced. Thus, in one or more forms, the invention is a method of reducing the refrigeration requirements of a shipping container or other cooled enclosure in the absence of a controlled atmosphere control system.

As disclosed above, the pre-set fixed opening of the vent is selected based on one or more characteristics of the respiring produce and one or more operating parameters of the membrane system. Preferably, the one or more characteristics of the respiring produce include at least the respiration rate of the respiring produce and the mass or volume of the respiring produce.

In one or more forms of the invention, the method includes opening or partially opening the vent to the pre-set opening size based on one or more characteristics of the respiring produce and one or more operating parameters of the membrane system.

In an embodiment, the vent is operated independently of a controller or control system.

As disclosed above, the membrane system is operated according to a pre-set mode, and the pre-set mode is independent of a measured gas concentration or pressure.

By way of clarification, the pre-set mode is not adjusted, altered, or controlled (such as by a controller or control system) in response to a measured gas concentration (e.g. CO₂, N₂, O₂ concentrations), or pressure of the internal environment.

This method of operation is useful for reducing the refrigeration requirements of a shipping container or other cooled enclosure. The inventors have also found that in certain forms of the invention the overall energy requirements of the system can be further reduced.

There are certain times when the air temperature of the external environment has decreased (for example overnight) such that the power consumption by the membrane system exceeds the heat load of incoming air. In such instances, it is preferable to deactivate the membrane system and instead maintain the CO₂ and O₂ concentrations through fresh air exchange. Thus, in one form of the invention, the air temperature of the internal environment is monitored and the air temperature of the external environment is monitored. In an embodiment, the method further includes: determining a temperature differential between the air temperature of the exterior environment and the air temperature of the internal environment, and deactivating the membrane system if the temperature differential is below a threshold value. Preferably, the method further includes opening a secondary vent or valve to draw additional external air or permit additional external air to pass into the enclosure through the secondary vent or valve at a volumetric flow rate sufficient to maintain CO₂ removal at the pre-set mode of the membrane system. The secondary vent or valve may be operated at constant flow or varied in accordance with a desired regime, e.g. the secondary vent or valve is an adjustable vent or valve. More preferably, the method additionally includes reactivating the membrane system when the temperature differential has increased to or above the threshold value. For avoidance of doubt, the membrane system is operated according to the pre-set mode upon reactivation.

In one or more embodiments of the invention, the pre-set mode is independent of any measured variables of the internal environment. By way of clarification, the pre-set mode is not adjusted, altered, or controlled (such as by a controller or control system) in response to any measured variable of the internal environment, such variables include (but are not limited to) gas concentration (e.g. CO₂, N₂, O₂ concentrations), pressure, temperature, air flow rates through an inlet/outlet of the vent, etc.

In one or more embodiments, the method includes initially selecting the pre-set mode according to one or more characteristics of the respiring produce. In such embodiments, the pre-set mode is selected from the group consisting of: a pre-set constant gas throughput, a pre-set variable gas throughput, a pre-set constant electrical load, a pre-set variable electrical load, a pre-set constant pressure differential between an inlet and an outlet of the membrane system, a pre-set variable pressure differential between an inlet and an outlet of the membrane system, a pre-set constant pump speed on a pump associated with the retentate side of the membrane, or a pre-set variable pump speed on a pump associated with a retentate side of the membrane. For avoidance of doubt, in the case of a pre-set variable operating strategy (whether gas throughput, electrical load, pressure differential, or pump speed), the membrane system is configured to be controlled and operated by a controller or control system to implement the pre-set variable operating strategy independent of any measured variables of the internal environment.

In alternative embodiments, the pre-set mode is additionally independent of one or more characteristics of the respiring produce. In such embodiments, it is preferred that the pre-set mode is a fixed mode of operation. That is, the pre-set mode is not adjusted, altered, or otherwise controlled (such as by a controller or control system) in response to a measured or modelled characteristic or change in characteristic of the respiring produce. More preferably, the fixed mode of operation is selected from: a pre-set constant gas throughput, a pre-set constant electrical load, a pre-set constant pressure differential between an inlet and an outlet of the membrane system, a pre-set constant pump speed on a pump associated with the retentate side of the membrane. Still more preferably, the method further includes an initial step of activating the membrane system at the fixed mode of operation.

In an embodiment, the membrane system is operated independently of a controller or control system.

It will be appreciated that in one or more forms of the invention, the membrane system includes a retentate side gas circulation system. The retentate side gas circulation system may include one or more pumps, such as one or more pumps located upstream of the CO₂ selective membrane and/or one or more pumps located downstream of the CO₂ selective membrane. While variable drive speed pumps may be used, it is preferred that each pump is operated at a single speed. Given this, it is further preferable that each pump is a single speed pump.

In an embodiment, the membrane system includes a single pump retentate side gas circulation system for passing the cooled CO₂-rich air stream to the CO₂ selective membrane and returning the cooled CO₂-lean air stream to the internal environment. In one form of this embodiment, the single pump is located upstream of the CO₂ selective membrane and the step of passing the cooled CO₂-rich air through the CO₂ selective membrane includes: providing air to the CO₂ selective membrane under positive pressure. In an alternative form of this embodiment, the single pump is located downstream of the CO₂ selective membrane and the step of passing the cooled CO₂-rich air stream through the CO₂ selective membrane includes drawing air through the CO₂ selective membrane under negative pressure.

It will be appreciated that in one or more forms of the invention, the membrane system includes a permeate side gas circulation system, also commonly referred to as a sweep gas circulation system. In such embodiments, the CO₂-rich permeate stream is a CO₂-rich sweep stream. The permeate side gas circulation system may include one or more sweep pumps, such as one or more sweep pumps located upstream of an inlet to a permeate side of the CO₂ selective membrane and/or one or more sweep pumps located downstream of an outlet to the permeate side of the CO₂ selective membrane. Although it is preferred that the permeate side gas circulation system includes the one or more pumps downstream of the outlet. While variable drive speed sweep pumps may be used, it is preferred that each sweep pump is operated at a single speed. Given this, it is further preferable that each sweep pump is a single speed pump.

In an embodiment, the method further includes replacing a portion of CO₂-rich air from the internal environment with fresh air through the open air vent. Preferably, the air vent has a pre-set opening size selected according to one or more characteristics of the respiring produce (e.g. a type, mass, volume etc.). More preferably, the pre-set sized opening is manually set and is independent of any monitored condition of the internal environment. Alternatively, the pre-set sized opening is configured to be adjusted by a controller in response to a monitored condition of the internal environment.

In an embodiment, the refrigerated shipping container or other cooled enclosure is not operated under controlled atmosphere conditions. Preferably, the enclosure does not include a controlled atmosphere control system.

In a second aspect of the invention, there is provided a refrigerated shipping container or other cooled enclosure containing respiring produce, including a control system configured to be operated according to the above-defined method.

In particular, the enclosure may be programmed to carry out the following steps:

pass a cooled CO₂-rich air stream from an internal environment within the enclosure through a CO₂ selective membrane of a membrane system to produce a cooled CO₂-lean air stream and a CO₂-rich permeate stream;

retain or return the cooled CO₂-lean air stream to the internal environment; and

exhaust the CO₂-rich permeate stream to an external environment outside of the enclosure;

the control system further programmed to draw external air or permit external air to pass into the enclosure through an air vent with a pre-set fixed opening of the enclosure in a volume to at least balance a volume difference between the cooled CO₂-rich air stream and the cooled CO₂-lean air stream;

wherein the control system operates the membrane system according to a pre-set mode, the pre-set mode being independent of a measured gas concentration or pressure of the internal environment; and

wherein the pre-set fixed opening of the vent is selected based on one or more characteristics of the respiring produce and the pre-set mode of the membrane system. In a third aspect of the invention, there is provided a refrigerated shipping container or other cooled enclosure configured to transport or store respiring produce, including:

a membrane system including:
a gas inlet open to an internal environment within the enclosure;
a first gas outlet open to the internal environment within the enclosure;
a second gas outlet open to an external environment outside the shipping container;
a CO₂ selective membrane configured to:
   receive a cooled CO₂-rich air stream from the internal environment via the gas inlet, and to separate at least a portion of CO₂ from the cooled CO₂-rich air stream to form a cooled CO₂-lean air stream on a first side of the CO₂ selective membrane and a CO₂-rich permeate stream on a second side of the CO₂ selective membrane, and
   discharge the cooled CO₂-lean air stream through the first gas outlet and the CO₂-rich permeate stream through the second gas outlet, and
gas circulation means configured to pass the cooled CO₂-rich air from the internal environment through the CO₂ selective membrane;

wherein the membrane system is configured to be operated according to a pre-set mode, and the pre-set mode is independent of a measured gas concentration or pressure of the internal environment; and

wherein the enclosure includes an air vent with an opening, the air vent configured to be opened to a selected pre-set fixed opening based on one or more characteristics of the respiring produce and the pre-set mode of the membrane system.

In an embodiment, the pre-set mode is operated independently of a controller or control system in response to a change in gas composition or pressure within the internal environment. That is, the pre-set mode is not configured to be adjusted, altered, or controlled (such as by a controller or control system) in response to a measured gas concentration or pressure of the internal environment.

In an embodiment, the membrane system is deactivatable in response to an air temperature differential between an external environment (outside the enclosure) and an internal environment within the enclosure being at or below a set point value. Preferably, the enclosure further includes a secondary vent or valve that is configured to be opened to draw additional external air or permit additional external air to pass into the enclosure through the secondary vent or valve at a volumetric flow rate sufficient to maintain CO₂ removal at the pre-set mode of the membrane system.

In an embodiment, the pre-set mode is independent of any measured variables of the internal environment.

It will be appreciated that in one or more forms of the invention, the membrane system includes a retentate side gas circulation system. The retentate side gas circulation system may include one or more pumps, such as one or more pumps located upstream of the CO₂ selective membrane and/or one or more pumps located downstream of the CO₂ selective membrane. While variable drive speed pumps may be used, it is preferred that each pump is operated at a single speed. Given this, it is further preferable that each pump is a single speed pump.

In an embodiment, the membrane system includes a single pump retentate side gas circulation system for passing the cooled CO₂-rich air stream to the CO₂ selective membrane and returning the cooled CO₂-lean air stream to the internal environment. In one form of this embodiment, the single pump is located upstream of the CO₂ selective membrane and the step of passing the cooled CO₂-rich air through the CO₂ selective membrane includes: providing air to the CO₂ selective membrane under positive pressure. In an alternative form of this embodiment, the single pump is located downstream of the CO₂ selective membrane and the step of passing the cooled CO₂-rich air stream through the CO₂ selective membrane includes drawing air through the CO₂ selective membrane under negative pressure.

It will be appreciated that in one or more forms of the invention, the membrane system includes a permeate side gas circulation system, also commonly referred to as a sweep gas circulation system. In such embodiments, the CO₂-rich permeate stream is a CO₂-rich sweep stream. The permeate side gas circulation system may include one or more sweep pumps, such as one or more sweep pumps located upstream of an inlet to a permeate side of the CO₂ selective membrane and/or one or more sweep pumps located downstream of an outlet to the permeate side of the CO₂ selective membrane. Although it is preferred that the permeate side gas circulation system includes the one or more pumps downstream of the outlet. While variable drive speed sweep pumps may be used, it is preferred that each sweep pump is operated at a single speed. Given this, it is further preferable that each sweep pump is a single speed pump.

In an embodiment, the vent is operated independently of a controller or control system.

In an embodiment, the enclosure does not include a controlled atmosphere control system.

In a fourth aspect of the invention, there is provided a CO₂ selective gas membrane module when used in a refrigerated shipping container or other cooled enclosure that does not include a controlled atmosphere control system, the membrane module including:

a mount for installing the membrane module into the enclosure;

a gas inlet configured to be open to an internal environment within the enclosure;

a first gas outlet configured to be open to the internal environment within the enclosure;

a second gas outlet configured to be open to an external environment outside the enclosure;

a CO₂ selective membrane configured to:
receive a cooled CO₂-rich air stream from the internal environment via the gas inlet, and to separate at least a portion of CO₂ from the cooled CO₂-rich air stream to form a cooled CO₂-lean air stream on a first side of the CO₂ selective membrane and a CO₂-rich permeate stream on a second side of the CO₂ selective membrane, and
discharge the cooled CO₂-lean air stream through the first gas outlet and the CO₂-rich permeate stream through the second gas outlet; and
gas circulation means configured to pass the cooled CO₂-rich air from the internal environment through the CO₂ selective membrane;

wherein the membrane system is configured to be operated according to a pre-set mode and the pre-set mode is independent of a measured gas concentration or pressure of an internal environment of the enclosure.

In an embodiment, the pre-set mode is independent of any measured variable of the internal environment.

It will be appreciated that in one or more forms of the invention, the membrane system includes a retentate side gas circulation system. The retentate side gas circulation system may include one or more pumps, such as one or more pumps located upstream of the CO₂ selective membrane and/or one or more pumps located downstream of the CO₂ selective membrane. While variable drive speed pumps may be used, it is preferred that each pump is operated at a single speed. Given this, it is further preferable that each pump is a single speed pump.

In an embodiment, the membrane system includes a single pump retentate side gas circulation system for passing the cooled CO₂-rich air stream to the CO₂ selective membrane and returning the cooled CO₂-lean air stream to the internal environment. In one form of this embodiment, the single pump is located upstream of the CO₂ selective membrane and the step of passing the cooled CO₂-rich air through the CO₂ selective membrane includes: providing air to the CO₂ selective membrane under positive pressure. In an alternative form of this embodiment, the single pump is located downstream of the CO₂ selective membrane and the step of passing the cooled CO₂-rich air stream through the CO₂ selective membrane includes drawing air through the CO₂ selective membrane under negative pressure.

It will be appreciated that in one or more forms of the invention, the membrane system includes a permeate side gas circulation system, also commonly referred to as a sweep gas circulation system. In such embodiments, the CO₂-rich permeate stream is a CO₂-rich sweep stream. The permeate side gas circulation system may include one or more sweep pumps, such as one or more sweep pumps located upstream of an inlet to a permeate side of the CO₂ selective membrane and/or one or more sweep pumps located downstream of an outlet to the permeate side of the CO₂ selective membrane. Although it is preferred that the permeate side gas circulation system includes the one or more pumps downstream of the outlet. While variable drive speed sweep pumps may be used, it is preferred that each sweep pump is operated at a single speed. Given this, it is further preferable that each sweep pump is a single speed pump.

In a fifth aspect of the invention, there is provided a method of installing a system according to the fourth aspect of the invention in a refrigerated shipping container or other cooled enclosure that does not include a controlled atmosphere control system.

In a sixth aspect of the invention, there is provided a method of modifying a controlled atmosphere refrigerated shipping container or other cooled enclosure to provide a cooled enclosure according to the second or third aspects, the method including removing from the controlled atmosphere control system from the enclosure.

In a seventh aspect of the invention, there is provided a method for reducing refrigeration energy requirements in operation of a refrigerated shipping container or other cooled enclosure containing respiring produce, the method including:

a membrane exhaust step of drawing and/or driving air from the interior of the enclosure through a CO₂ selective membrane of a membrane system installed in the enclosure, and exhausting the resulting CO₂-rich downstream air stream to the exterior of the enclosure; and

an atmosphere replenishment step of causing or permitting ambient air from the exterior of the enclosure to pass into the container to balance the volume of air lost through the membrane;

wherein the method is conducted in the absence of controlled atmosphere operation, such that neither the membrane exhaust step nor the atmosphere replenishment step is conducted in accordance with the monitoring of a gas concentration or pressure in the interior of the enclosure.

The method disclosed above may include one or more features of the methods previously described.

In an embodiment, neither the membrane exhaust step nor the atmosphere replenishment step is conducted in accordance with any prevailing conditions in the interior of the cooled enclosure.

In this way, the fact that the membrane exhaust step has the effect of reducing the CO₂ concentration in the interior of the enclosure provides that the atmosphere replenishment step requires a smaller volume of ambient air to be introduced in order to maintain the CO₂ concentration at an acceptable level for the respiring produce than would otherwise be the case, irrespective of the lack of active control of the membrane exhaust step or the atmosphere replenishment step (i.e. the enclosure need not be provided with any means for monitoring CO₂ concentration or other gas constituents for such control). This is in marked contrast to known membrane systems used in shipping container operation and cooled storage environments, in which active control is required.

The invention contemplates application of the methods and systems described above to a variety of environments in which respiring content is transported or stored, or there are other advantages in such enclosure for effecting controlled atmosphere content due to such respiration. Such environments include: buildings, public transport (such as cars, buses, trains, planes, boats etc. which contain respiring individuals), and the storage and transport of livestock.

In view of the above, there is disclosed herein a method for reducing cooling energy requirements in operation of a cooled enclosure containing respiring content, the method including:

a membrane exhaust step of drawing and/or driving air from the interior of the cooled enclosure through a CO₂ selective membrane of a membrane system installed in the cooled enclosure, and exhausting the resulting CO₂-rich downstream air stream to the exterior of the cooled enclosure; and

an atmosphere replenishment step of causing or permitting ambient air from the exterior of the cooled enclosure to pass into the cooled enclosure to balance the volume of air lost through the membrane;

wherein the method is conducted in the absence of controlled atmosphere operation, such that neither the membrane exhaust step nor the atmosphere replenishment step is conducted in accordance with the monitoring of a gas concentration or pressure in the interior of the cooled enclosure.

The method disclosed above may include one or more features of the methods previously described.

The method disclosed above may include one or more features of the methods previously described.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a photograph of a refrigeration panel of a refrigerated shipping container.

FIG. 2 is a schematic of a membrane separation system for installation into a refrigerated shipping container.

FIG. 3 is a schematic illustrating one embodiment of the membrane separation system.

FIG. 4 is a graph showing modelled results of equilibrium CO₂ concentration within a shipping container as a function of membrane surface area for bananas and avocados for different respiration rates.

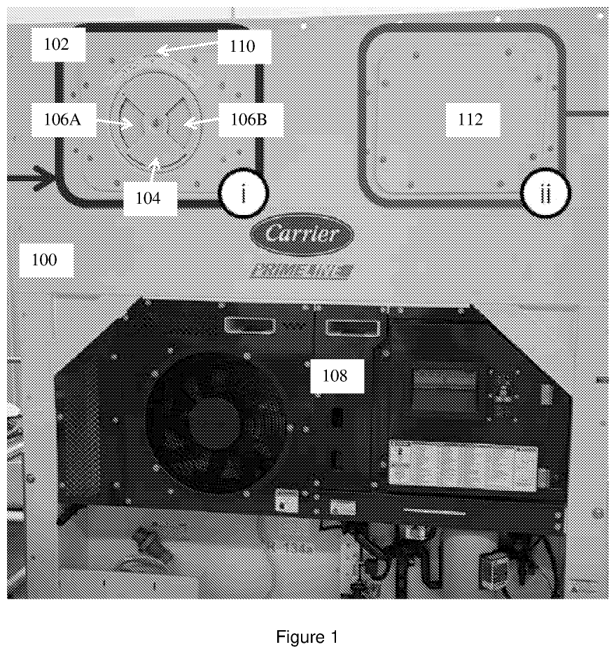

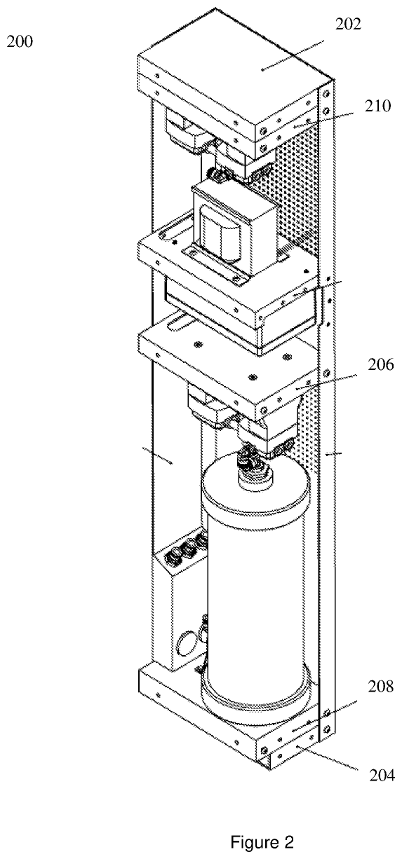

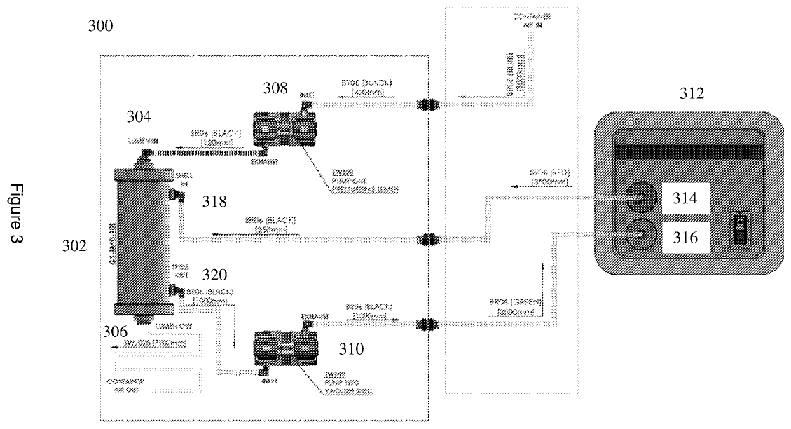

### DETAILED DESCRIPTION OF THE EMBODIMENTS

The invention relates to a method and/or apparatus for storing and/or transporting respiring produce in an unsealed refrigerated shipping container or other cooled enclosure without an actively controlled atmosphere. Respiring produce produces CO₂ which needs to be removed from the internal environment of the refrigerated shipping container to preserve the freshness of the respiring produce. Such respiring produce typically includes fruit, vegetables, plants, seedlings, plant materials, and the like.

It will be appreciated that the methodology and system is applied without a ‘controlled atmosphere’ regime. A controlled atmosphere regime is associated with a substantially sealed reefer, and is one in which one or more conditions of the internal atmosphere are monitored, and operation of the membrane system is controlled (such as via a controller or control system) to maintain the one or more monitored conditions

What is claimed is:

1. A method for operating a refrigerated shipping container or other cooled enclosure containing respiring produce, the method including:
passing a cooled CO₂-rich air stream from an internal environment within the enclosure through a CO₂ selective membrane of a membrane system to produce a cooled CO₂-lean air stream and a CO₂-rich permeate stream;
retaining or returning the cooled CO₂-lean air stream to the internal environment;
exhausting the CO₂-rich permeate stream to an external environment outside of the enclosure; and
drawing external air or permitting external air to pass into the enclosure through an air vent with a pre-set fixed opening of the enclosure in a volume to at least balance a volume difference between the cooled CO₂-rich air stream and the cooled CO₂-lean air stream;
wherein the membrane system is operated according to a pre-set mode, and the pre-set mode is independent of a measured gas concentration or pressure of the internal environment; and
the pre-set fixed opening of the vent is selected based on one or more characteristics of the respiring produce and the pre-set mode of the membrane system.

2. The method of claim 1, wherein the vent is operated independently of a controller or control system.

3. The method of claim 1, wherein the pre-set mode is not adjusted, altered, or controlled in response to any measured variable of the internal environment.

4. The method of claim 1, wherein the method further includes initially selecting the pre-set mode according to one or more characteristics of the respiring produce.

5. The method of claim 1, wherein the pre-set mode is selected from the group consisting of: a pre-set constant gas throughput, a pre-set variable gas throughput, a pre-set constant electrical load, a pre-set variable electrical load, a pre-set constant pressure differential between an inlet and an outlet of the membrane system, a pre-set variable pressure differential between an inlet and an outlet of the membrane system, a pre-set constant pump speed on a pump associated with the retentate side of the membrane, or a pre-set variable pump speed on a pump associated with a retentate side of the membrane.

6. The method of claim 1, wherein the pre-set mode is additionally independent of one or more characteristics of the respiring produce.

7. The method of claim 6, wherein the pre-set mode is a fixed mode of operation.

8. The method of claim 7, wherein the pre-set mode is not adjusted, altered, or controlled.

9. The method of claim 8, wherein the fixed mode of operation is selected from: a pre-set constant gas throughput, a pre-set constant electrical load, a pre-set constant pressure differential between an inlet and an outlet of the membrane system, a pre-set constant pump speed on a pump associated with the retentate side of the membrane.

10. The method of claim 1, wherein the membrane system is operated independently of a controller or control system.

11. The method of claim 1, wherein the cooled enclosure is not operated under controlled atmosphere conditions.

12. A refrigerated shipping container or other cooled enclosure for containing respiring produce, including a control system programmed to carry out the following:
pass a cooled CO₂-rich air stream from an internal environment within the enclosure through a CO₂ selective membrane of a membrane system to produce a cooled CO₂-lean air stream and a CO₂-rich permeate stream;
retain or return the cooled CO₂-lean air stream to the internal environment; and exhaust the CO₂-rich permeate stream to an external environment outside of the enclosure;
the control system further programmed to draw external air or permit external air to pass into the enclosure through an air vent with a pre-set fixed opening of the enclosure in a volume to at least balance a volume difference between the cooled CO₂-rich air stream and the cooled CO₂-lean air stream;
wherein the control system operates the membrane system according to a pre-set mode, the pre-set mode being independent of a measured gas concentration or pressure of the internal environment; and
wherein the pre-set fixed opening of the vent is selected based on one or more characteristics of the respiring produce and the pre-set mode of the membrane system.

13. A refrigerated shipping container or other cooled enclosure configured to transport or store respiring produce, including:
a membrane system including:
a gas inlet open to an internal environment within the enclosure;
a first gas outlet open to the internal environment within the enclosure;
a second gas outlet open to an external environment outside the enclosure;
a CO₂ selective membrane configured to:
receive a cooled CO₂-rich air stream from the internal environment via the gas inlet, and to separate at least a portion of CO₂ from the cooled CO₂-rich air stream to form a cooled CO₂-lean air stream on a first side of the CO₂ selective membrane and a CO₂-rich permeate stream on a second side of the CO₂ selective membrane, and
discharge the cooled CO₂-lean air stream through the first gas outlet and the CO₂-rich permeate stream through the second gas outlet, and
gas circulation apparatus configured to pass the cooled CO₂-rich air from the internal environment through the CO₂ selective membrane;
wherein the membrane system is configured to be operated according to a pre-set mode, and the pre-set mode is independent of a measured gas concentration or pressure of the internal environment; and
wherein the enclosure includes an air vent with an opening, the air vent configured to be opened to a selected pre-set fixed opening based on one or more characteristics of the respiring produce and the pre-set mode of the membrane system.

14. The enclosure of claim 13, wherein the pre-set mode is operated independently of a controller or control system.

15. The enclosure of claim 13, wherein the pre-set mode is independent of any measured variables of the internal environment.

16. The enclosure of claim 13, wherein the vent is operated independently of a controller or control system.

17. The enclosure of claim 13, wherein the enclosure does not include a controlled atmosphere control system.

18. A CO₂ selective gas membrane module when used in a refrigerated shipping container or other cooled enclosure that does not include a controlled atmosphere control system, the membrane module including:
a mount for installing the membrane module into the enclosure;
a gas inlet configured to be open to an internal environment within the enclosure;
a first gas outlet configured to be open to the internal environment within the enclosure;
a second gas outlet configured to be open to an external environment outside the enclosure;
a CO₂ selective membrane configured to:
receive a cooled CO₂-rich air stream from the internal environment via the gas inlet, and to separate at least a portion of CO₂ from the cooled CO₂-rich air stream to form a cooled CO₂-lean air stream on a first side of the CO₂ selective membrane and a CO₂-rich permeate stream on a second side of the CO₂ selective membrane, and
discharge the cooled CO₂-lean air stream through the first gas outlet and the CO₂-rich permeate stream through the second gas outlet; and
gas circulation apparatus configured to pass the cooled CO₂-rich air from the internal environment through the CO₂ selective membrane;
wherein the membrane system is configured to be operated according to a pre-set mode and the pre-set mode is independent of a measured gas concentration or pressure of an internal environment of the enclosure.

19. A method of installing a membrane module according to claim 18 in a refrigerated shipping container or other cooled enclosure that does not include a controlled atmosphere control system.

20. A method of modifying a controlled atmosphere refrigerated shipping container or other controlled atmosphere cooled enclosure to provide a cooled enclosure according to claim 12, the method including removing the controlled atmosphere control system from the enclosure.

21. A method for reducing refrigeration energy requirements in operation of a refrigerated shipping container or other cooled enclosure containing respiring produce, the method including:
a membrane exhaust activity involving drawing and/or driving air from the interior of the enclosure through a CO₂ selective membrane of a membrane system installed in the enclosure, and exhausting the resulting CO₂-rich downstream air stream to the exterior of the enclosure; and
an atmosphere replenishment activity involving causing or permitting ambient air from the exterior of the enclosure to pass into the enclosure to balance the volume of air lost through the membrane;
wherein the method is conducted in the absence of controlled atmosphere operation, such that neither the membrane exhaust activity nor the atmosphere replenishment activity is conducted in accordance with the monitoring of a gas concentration or pressure in the interior of the enclosure.
